(19) United States
(12) Patent Application Publication
(10) Pub. No.: US 2026/0284928 A1
(43) Pub. Date: Sep. 24, 2026

(54) METHOD OF PRODUCING A BUILDING PANEL AND A BUILDING PANEL

(71) Applicant: Välinge Innovation AB, Viken (SE)

(72) Inventors: Göran ZIEGLER, VIKEN (SE); Sofia BERGENDAL, JONSTORP (SE); Daniel SCIALANGA, HELSINGBORG (SE); Frederik SAND, HELSINGBORG (SE)

(73) Assignee: Välinge Innovation AB, Viken (SE)

(21) Appl. No.: 19/574,682

(22) Filed: Mar. 23, 2026

(30) Foreign Application Priority Data
Mar. 24, 2025 (SE) 2550272-5

(51) Int. Cl. B27N 3/00; B27N 3/02

(52) U.S. Cl. CPC B27N 3/002; B27N 3/02

(57) ABSTRACT

A method for producing a building panel is provided. The method comprises providing a substrate (1), applying a front layer (2) comprising a no added formaldehyde (NAF) binder (6a) on a front surface (4) of the substrate (1), wherein said NAF binder (6a) is a thermosetting binder, and thereafter applying heat and pressure to the front layer (2) and the substrate (1), thereby at least partially curing the NAF binder (6a) of the front layer (2), to form said building panel. The substrate (1) may have an internal bond strength of 0.2-2.0 N/mm², such as 0.5-1.5 N/mm², wherein internal bond strength is measured in accordance with EN319. A building panel produced with the method is also provided.

### CROSS REFERENCE TO RELATED APPLICATIONS

The present application claims the benefit of Swedish Application No. 2550272-5, filed on Mar. 24, 2025. The entire contents of Swedish Application No. 2550272-5 are hereby incorporated herein by reference in their entirety.

### TECHNICAL FIELD

The present disclosure relates to a method of producing a building panel, such as a floor panel, and to such building panel.

### TECHNICAL BACKGROUND

Several technologies are used to provide a floor panel, which is an imitation of a solid floor panel. The reason is that imitations may be produced more cost efficiently and a floor with a separate layer attached to a core of for example HDF or plywood is more moisture stable than solid wood floors.

Wood fiber based direct pressed laminated flooring usually comprises a core of a fiber board, an upper decorative surface layer of laminated paper and a lower balancing layer of laminate, plastic, paper or like material.

A laminate surface generally comprises two paper sheets, a printed decorative paper and a transparent overlay intended to protect the decorative paper from abrasion. The transparent overlay, which is made of refined fibers (e.g. α-cellulose fibers), comprises small hard and transparent aluminum oxide particles.

The printed decorative paper and the overlay are generally impregnated with melamine-formaldehyde resin and laminated to a wood fiber-based core under heat and pressure.

The wear layer could also be produced without a cellulose overlay. In such a case melamine-formaldehyde resin and aluminium oxide particles are applied as a lacquered layer directly on the decorative paper with similar methods as described above. Such a wear layer is generally referred to as liquid overlay.

“Paper free” floor types have been developed where powder technology is used to obtain a surface comprising a substantially homogenous mix of non-processed wood fibers, binders and wear resistant particles. The wear resistant particles are preferably aluminum oxide particles, silica or silicon carbide, and the binders are preferably thermosetting resins such as melamine-formaldehyde. In general, all these materials are preferably applied in dry form as a mixed powder on a HDF core and cured under heat and pressure The resulting solid surface layer provides high impact and wear resistance. WO2009/065769 describes a building panel comprising a wood fiber core and a surface layer comprising a substantially homogenous mix of wood fibers, a binder and wear resistant particles. The binder of the powder-based surface layer described in WO2009/065769 is e.g. a formaldehyde-based binder, such as a melamine formaldehyde binder, a urea-formaldehyde binder, a phenol-formaldehyde binder or combinations thereof.

Formaldehyde-based binders, such as melamine-formaldehyde binders and urea-formaldehyde binders, are known to be robust and highly durable thermosetting binders, that are vastly used within the flooring and furniture industries. A problem is that both formaldehyde and melamine are considered harmful. Melamine is listed on the candidate list of substances of very high concern under REACH (the European Registration, Evaluation, Authorization and restriction of CHemicals), and formaldehyde is known to be carcinogenic to humans and harmful to the environment and is under increased legislative pressure.

Formaldehyde emissions from flooring and furniture products may be a problem for workers during manufacturing, also, emissions from installed floorings may sometimes be considered as a health risk to consumers. The growing environmental concerns and stringent legislative requirements to the formaldehyde emissions from wood-based panels poses new challenges to researchers and the industry, related to the development of sustainable, eco-friendly wood-based panels, with very low formaldehyde emission.

Although formaldehyde-based binders are robust and highly durable thermosetting binders, this kind of binders, and in particular melamine-formaldehyde binders, result in shrinkage, or contraction forces acting on the building panel. These contraction forces are induced when the formaldehyde-based binders cure but can also appear when the cured binders are exposed to climate changes, like changes in temperature and/or humidity. A building panel comprising a melamine-formaldehyde binder requires a substrate or core with a certain internal bond strength, to withstand these contraction forces. Urea-formaldehyde binders may not induce as much contraction forces in the building panel as melamine-formaldehyde binders do. However, it is often a problem to achieve the quality required for a high-quality laminate building panel with a urea-formaldehyde binder. Parameters like moisture resistance and chemical resistance may may be too poor with a urea-formaldehyde binder.

Further on, both the melamine-formaldehyde and the urea-formaldehyde resin curing reactions are condensation reactions, resulting in the formation of water upon curing. This water can give rise to an uneven surface of the building panel, such as an orange peel-like texture, or even generate blisters in the surface of the building panel. The risk for this increases at higher temperatures and longer pressing times. The formed water and the increased temperature may induce a steam explosion in the core, resulting in disruption of the core.

For the reasons above, at least for some applications, like making high-quality laminate floorings, it is predominantly high quality HDF cores (with relatively high internal bond strength) that are used as substrates. Production of high quality HDF cores is, however, energy-consuming and relatively costly. It would be desirable if alternative substrates could be used for producing building panels. Also, building panels comprising a formaldehyde-based binder in the surface layer requires a balancing layer at the opposite side of the core, to counteract or balance the contraction forces caused by the shrinkage of the surface layer.

The construction industry, as the rest of the society, is currently going through a shift towards more sustainable production processes and raw materials.

From the above it is understood that there is room for improvements, and the present disclosure aims to solve or at least mitigate the above and other problems.

### SUMMARY

An overall object of embodiments of the present disclosure is to provide an improvement over the above-described techniques and known art.

It is an object of at least embodiments of the present disclosure to provide an improved method for producing a building panel comprising a no added formaldehyde (NAF) binder, and such a building panel.

It is another object of embodiments of the present disclosure to provide a method for producing a building panel that is a NAF (no added formaldehyde) panel and/or a NAM (no added melamine) panel.

It is an object of embodiments of the present disclosure to provide a method for producing a building panel wherein the substrate comprises recycled material and/or virgin biobased material.

It is an object of embodiments of the present disclosure to provide a method for producing a building panel that is more sustainable than methods for producing building panels known in the art.

It is another object of embodiments of the present disclosure to provide a building panel that is a no added formaldehyde (NAF) panel and/or a no added melamine (NAM) panel.

It is an object of embodiments of the present disclosure to provide a building panel comprising a thermosetting resin, wherein the emission of formaldehyde from the finished building panel is essentially eliminated, compared to known building panels comprising thermosetting resins.

It is an object of embodiments of the present disclosure to provide a building panel comprising a substrate comprising recycled material and/or virgin biobased material.

It is yet another object of embodiments of the present disclosure to provide a building panel that has a lower carbon footprint than building panels known in the art.

In the scope of the present disclosure, the terms “substrate” and “core” may be used interchangeably.

In a first aspect of the disclosure, a method for producing a building panel is provided. The building panel may preferably be configured to be a floor panel, a furniture component, a worktop, a wall panel or a ceiling panel.

The method comprises providing a substrate, applying a front layer comprising a no added formaldehyde (NAF) binder on a front surface of the substrate, and thereafter applying heat and pressure to the front layer and the substrate, thereby at least partially curing the NAF binder of the front layer to form said building panel. The NAF binder may preferentially be a thermosetting binder.

A no added formaldehyde (NAF) binder may be defined as a binder to which no formaldehyde or formaldehyde-containing composition has been added. However, as formaldehyde is found naturally in every living system, from plants to animals and humans, there may be trace amounts of formaldehyde present also in a NAF binder. Such trace amounts may be less than 0.5 wt-%, such as less than 0.1 wt-% or such as less than 0.01 wt-%.

The NAF binder of the front layer may additionally be a no added melamine (NAM) binder. A NAM binder may be defined as a binder to which no melamine or melamine-containing composition has been added. A NAM binder may be substantially free from melamine. This is advantageous as melamine is listed on the candidate list of substances of very high concern under REACH (the European Registration, Evaluation, Authorization and restriction of CHemicals), and the use of it is likely to be restricted in the future.

The front layer may comprise at least 25 wt-% of the NAF binder. The front layer may comprise at least 25 wt-%, such as at least 50 wt-%, such as at least 60 wt-% of the NAF binder.

The NAF binder of the front layer may comprise one or more of polyester, unsaturated polyester, epoxy, polyurethane, acrylate, natural polymers such as lignin, or a combination thereof.

The front layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN) in the front layer.

The front layer may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse. The fillers may be inorganic fillers such as calcium carbonate, barium sulphate, silicon dioxide, kaolin, talc, mica and/or wollastonite.

The front layer may comprise 0-60 wt-%, such as 20-40 wt-% of lignocellulosic materials.

The front layer may comprise 0-75 wt-%, such as 5-25 wt-% of inorganic fillers.

The front layer may comprise 25-100 wt-%, such as 50-100 wt-% or 60-100 wt-% of NAF binder.

The front layer may comprise less than 10 wt-%, such as less than 5 wt-%, less than 1 wt-%, or less than 0.1 wt-% of formaldehyde or a formaldehyde-comprising composition.

The front layer may comprise less than 1 wt-% such as less than 0.1 wt-% of melamine.

The front layer may be substantially free from formaldehyde.

The front layer may be substantially free from melamine.

The front layer may be applied in powder form. The applied powder may be a dry powder, such as a powder having a moisture content of less than 3 wt-% such as less than 2 wt-% or 1-3 wt-%.

The front layer may be applied as a granulate.

A granulate may comprise powder particles that are agglomerated into larger, free-flowing particles. The powder particles inside the agglomerated, larger, free-flowing particles may have the same size as the powder particles in powder form. A granulate may be easier to handle than a powder. The risk for segregation of different kinds of particles within a mixture may be reduced if the mixture is applied as a granulate. The risk for dust formation may be reduced if the mixture is applied as a granulate.

The front layer may be applied in powder form and/or as a granulate.

The front layer may alternatively be applied as a sheet, as a liquid, as a spray, as a film or as a melt.

The front layer may be applied in an amount of 10-1000 g/m², such as 30-600 g/m², such as 100-450 g/m², 30-450 g/m² or 30-100 g/m².

The method may further comprise heating the front layer prior to applying heat and pressure to the front layer and the substrate. Depending on the type and composition of the front layer, this may be beneficial and contribute to adhering the front layer to the substrate, which may result in a more reliable process.

The step of heating the front layer may comprise applying IR radiation, heat, microwaves, hot air and/or steam on the front layer. The step of heating may comprise pressing or hot rolling. By applying heat, e.g., in the form of IR radiation, a binder of the front layer applied in powder form may be at least partially transformed into fluid form or at least sintered so the particles in the powder stick together. The binder melts when applying heat exceeding the melting point of the binder, resulting in improved adhering of the front layer to the substrate. Another advantage is that the risk of the binder in powder form being displaced or partly displaced, for example due to mechanical influence, impact, vibrations or air flow, after being applied to the substrate is decreased. As a thermosetting binder is used, the front layer is not completely cured during the step of applying heat. It may be heated enough to form a film. The adhesive properties of the front layer may remain after the step of heating the front layer.

The front layer may be heated without first applying moisture to the front layer or moisture may be applied to the front layer before the front layer is heated.

Within the field of building panels there are a number of different boards that can be used as the core, or substrate, of the building panel. One example is a fiber board. A fiber board is a wood composite that is prepared by mixing wood fibers with thermosetting resin. The fiber board is then hot pressed. Fiber boards can be produced with different densities and a fiber board with a density around 160-450 kg/m³ is referred to as a Low Density Fiberboard (LDF), a fiber board with a density around 600-800 kg/m³ is referred to as a Medium Density Fiberboard (MDF) and a fiber board with a density around 800-1000 kg/m³ is referred to as a High Density Fiberboard (HDF). MDF are usually used within the furniture industry as a replacer for solid wood and the HDF is usually used within the flooring industry. A majority of the wood fibers in both the MDF and the HDF are refined long and thin fibers.

Another example of a board is a particle board which may include a similar raw material as fiber boards, i.e. wood-based materials. The density of a particle board is generally between 500-750 kg/m³, or about 650 kg/m³. A difference between fiber boards and particle boards is that the wood material used for the particle board production is milled into wood chips of different sizes and not refined into fibers as in the fiber board production.

Other types of wood-based boards used in the building panel industry are plywoods, chipboards, oriented strand boards (OSB) and wood plastic composite panels.

The substrate used in the presently disclosed method may be a wood-based board, such as a low density fiberboard (LDF), a medium density fiberboard (MDF), a high density fiberboard (HDF), a plywood, a chipboard, an oriented strand board (OSB), a particle board, a wood plastic composite panel (WPC), a hardboard, a softboard or combinations thereof.

Internal bond strength is a measure of the strength of a substrate to resist rupturing in the direction perpendicular to the plane of the surface of the substrate. A building panel comprising a formaldehyde-based binder, especially a melamine-formaldehyde based binder, in the front layer requires a substrate with a relatively high internal bond strength. The high internal bond strength is required to withstand contraction forces induced when the formaldehyde-based binder cures, but also contraction forces that can appear when the cured binder is exposed to climate changes. If a front layer comprising a formaldehyde-based binder is used, there is an increased risk that contraction forces will cause damaging, such as rupturing or chipping, of the building panel, due to the tension caused by contraction forces.

The risk of rupturing or chipping of a building panel is even higher if the building panel comprises a mechanical locking profile along an edge of the panel. Further on, the melamine formaldehyde resin curing is a condensation reaction, during which water is released as a by-product, resulting in the formation of water upon curing. If the internal bond strength of the substrate is too low, this release of water may generate blisters or even cause a steam explosion within the building panel, thus damaging the building panel.

To avoid damaging, the substrate needs to have an internal bond strength that is relatively high. This is especially true for application areas where high resin loadings are used such as deep structured laminates or powder based products. Using melamine-formaldehyde resins in these applications would give rise to very high internal tension. The need for a counter balancing layer as well as the introduction of a mechanical locking system to such a panel accentuates the high internal tensions.

Therefore, it is predominantly HDF substrates of a relatively high quality that are used in such applications, such as HDF substrates with an internal bond strength of about 1.8 N/mm² or higher wherein internal bond strength is measured in accordance with EN319.

High quality HDF substrates are, however, energy-consuming and relatively complicated to produce, since the wood fibers need to be refined before they are used in the board. Standard HDF boards also contains a formaldehyde-based binder, typically urea-formaldehyde, and may emit low levels of formaldehyde, especially when new. It would be highly beneficial if substrates with a better environmental profile than high quality HDF boards could be used as substrates in building panels.

It has now been found by the present inventors that, with the presently disclosed method, comprising applying a front layer based on a thermosetting NAF binder, substrates with a lower internal bond strength may be used compared to conventional methods wherein a front layer based on a melamine-formaldehyde binder is used. The presently disclosed method may allow using alternatives to traditional high quality HDF boards for producing building panels. The presently disclosed method may facilitate the use of new, more environmentally friendly boards as substrates for producing building panels.

The substrate used in the presently disclosed method may have an internal bond strength of 0.2-2.5 N/mm², such as 0.2-2.0 N/mm², such as 0.5-1.5 N/mm², wherein internal bond strength is measured in accordance with EN319.

The presently disclosed method is particularly useful for producing building panels with substrates with an internal bond strength ranging from about 0.2 N/mm² to about 2.0 N/mm², such as from about 0.5 N/mm² to about 1.5 N/mm², wherein internal bond strength is measured in accordance with EN319. The internal bond strength of such substrates may be too low to enable the use of a traditional melamine-formaldehyde binder in an applied front layer. If a front layer comprising a melamine-formaldehyde binder would be applied on such a substrate, the building panel may be deformed due to contraction forces induced when the melamine-formaldehyde binder cures. This is especially true for application areas where high resin loadings are used such as deep structured laminates or powder based products such as products with Nadura®. In those application areas the structure depth is made primarily in resin rich components such as paper or powder layers. Those components, being mainly melamine-formaldehyde based, would give rise to very high internal tension. In addition, due to the need for counter balancing, a similar internal tension is put on the opposing side. Hence, the internal forces work on both sides and the stress is high on the core. If a mechanical locking system is introduced to such a panel the action of the high internal forces is accentuated. Introducing higher resin loadings also generate more moisture from the condensation reaction and the risk for steam explosion or at least blisters in the pressed material increases, especially at high production temperatures and long pressing times. If instead, and as according to the presently disclosed method, a NAF binder is used in the applied front layer, substrates with a lower internal bond and, thus, possibly a better environmental profile may be used.

Substrates with an even lower internal bond strength, such as an internal bond strength of 0.1-1.0 N/mm², such as 0.1-0.5 N/mm², wherein internal bond strength is measured in accordance with EN319, may be used in the presently disclosed method, for example for producing furniture components, such as components for shelves or kitchen cabinets. It may be difficult to form a mechanical locking profile in a building panel with such a low internal bond strength. Such building panels may instead be attached to an underlying surface by for example gluing or stapling.

One way to improve the environmental profile of a building panel is to use a substrate comprising recycled material in the production process.

The substrate used in the method according to the first aspect of the present disclosure may comprise at least 50 wt-%, such as at least 80 wt-% of recycled material, such as recycled wood, recycled wood waste, recycled cardboard, recycled paper and/or recycled textile. The substrate may comprise 50-100 wt-% of recycled material.

In the scope of the present disclosure, recycled material means post-consumer and/or post-industrial material.

By using a substrate comprising recycled material, the sustainability of the method as presented above may be increased, compared to conventional methods for producing building panels. A substrate comprising recycled material may have a lower internal bond strength than substrates conventionally used for producing building panels. For example, such a substrate may have an internal bond strength of 0.2-2.0 N/mm², such as 0.5-1.5 N/mm², wherein internal bond strength is measured in accordance with EN319.

According to one example, the substrate used in the presently disclosed method may comprise at least 30 wt-%, such as at least 50 wt-% of virgin, biobased material, such as virgin lignocellulosic material and/or virgin textile material. The substrate may comprise 30-100 wt-% of virgin, biobased material. Virgin, biobased material may contribute to improving the sustainability of the method as presented above in several ways. For example, virgin biobased material that do not fulfil certain quality parameters, like color, to be used for example within the textile industry, may instead be used as raw material in a building panel. A substrate comprising virgin, biobased material may have a lower internal bond strength than substrates conventionally used for producing building panels. For example, such a substrate may have an internal bond strength of 0.2-2.0 N/mm², such as 0.5-1.5 N/mm², wherein internal bond strength is measured in accordance with EN319.

The substrate may preferentially be a no added formaldehyde (NAF) substrate and/or a no added melamine (NAM) substrate.

The method may further comprise applying a paper layer on the front layer and thereafter applying heat and pressure to the paper layer, the front layer and the substrate, to form a laminated building panel. The paper lay may preferentially be essentially unimpregnated when applied on said front layer. The step of applying heat and pressure to the paper layer, the front layer and the substrate preferentially comprises at least partly impregnating the paper layer with the NAF binder of the front layer. The paper layer may comprise a decorative paper. The paper layer may comprise a print, such as a digital print or an analog print, such as of a wood grain pattern.

In one example, the method further comprises applying a surface layer on the paper layer and thereafter applying heat and pressure to the surface layer, the paper layer, the front layer and the substrate, to form a laminated building panel. The surface layer may preferentially comprise a NAF binder.

Known laminated building panels produced with a front layer comprising melamine-formaldehyde resin, requires a backing layer or balancing layer, provided on a surface of the substrate being opposite the surface on which the front layer is provided. The melamine-formaldehyde results in shrinkage, or contraction forces acting on the building panel. Without the balancing layer, the product may be “cupping”, i.e., a first surface of the panel will shrink, the opposite surface will stretch correspondingly, resulting in a building panel with a concave cross section. Thus, a balancing layer is required to stabilize and/or balance the building panel to counteract those types of forces. In order to provide balance, the balancing layer may preferably comprise the same layers as provided on the opposite side of the substrate, at least preferably comprise the same binder as provided on the opposite side of the substrate. Providing a balancing layer to the building panel makes the production more expensive. This is both due to material costs, but also a more complicated production process with an additional step of providing, handling, and storing the balancing layer. Also, when a panel is balanced by applying a balancing layer, internal tension may be created in the panel as the two surfaces of the panel are subject to contraction forces working in opposite directions. These internal tensions may even cause cracks in or delamination of the substrate.

In the presently disclosed method, wherein a NAF binder is used in the front layer, possible contraction forces due to the front layer may be too small to require balance in the form of a balancing or backing layer.

The method may not comprise (be free of) a step of applying a backing layer to a back surface of the substrate opposite the front surface on which the front layer is applied.

There may however still be provided an optional backing layer, comprising e.g. a thin layer such as a lacquer, a varnish, an adhesive, a polymer-based sheet or foil, an impregnated paper or unimpregnated paper, a (colored) powder layer or a fabric, such as a woven or non-woven fabric.

The backing layer may be provided for informational, aesthetic, or decorative purposes.

The backing layer may be configured to form a moisture barrier. A backing layer configured to form a moisture barrier may comprise e.g. a thin layer such as a lacquer, a varnish, an adhesive, a polymer-based sheet or foil, an impregnated paper or a powder layer.

The method may further comprise applying a backing layer to a back surface of the substrate opposite the front surface on which the front layer is applied and, thereafter, applying heat and pressure to the front layer, the substrate and the backing layer, thereby at least partially curing the front layer, and the backing layer to form said building panel.

The backing layer preferably comprises a NAF binder, such as a thermosetting NAF binder or a thermoplastic NAF binder. A NAF binder of the backing layer may comprise one or more of polyester, unsaturated polyester, epoxy, acrylate, natural polymers such as lignin or a combination thereof.

The backing layer may comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The NAF binder of the backing layer may additionally be a no added melamine (NAM) binder.

The backing layer may comprise one or more of fillers, pigments, wear-resistant particles, lignocellulosic materials, such as wood fibers, and other additives. The wood fibers may preferably be made from recycled wood or wood waste. The wood fibers may come from post-consumer material, such as furniture, flooring or building elements. The wood waste may come from various wood handling processes such as furniture, flooring, or building production processes.

The lignocellulosic materials may also be one or more of hemp, grass, flax, straw and/or bagasse.

The backing layer may comprise 0-60 wt-%, such as 20-40 wt-% of lignocellulosic materials.

The backing layer may comprise 0-75 wt-%, such as 5-25 wt-% of inorganic fillers.

The backing layer may comprise 25-100 wt-%, such as 50-100 wt-% or 60-100 wt-% of NAF binder.

The backing layer may comprise less than 10 wt-%, such as less than 5 wt-%, less than 1 wt-%, or less than 0.1 wt-% of formaldehyde or a formaldehyde-comprising composition.

The backing layer may comprise less than 1 wt-%, or less than 0.1 wt-% of melamine.

The backing layer may be substantially free from formaldehyde.

The backing layer may be substantially free from melamine.

The backing layer may be applied in powder form. The applied powder may be a dry powder, such as a powder having a moisture content of less than 3 wt-% such as less than 2 wt-% or 1-3 wt-%.

The backing layer may be applied as a granulate.

The backing layer may be applied in powder form and/or as a granulate.

The backing layer may alternatively be applied as a sheet, as a liquid, as a spray, as a film or as a melt.

The backing layer may be applied in an amount of 10-1000 g/m², such as 30-600 g/m², such as 100-450 g/m² or 30-450 g/m².

The NAF binder of the front layer and/or the NAF binder of the backing layer may preferentially be a thermosetting binder, but the skilled artisan will appreciate that other binders, such as thermoplastic binders, are equally conceivable.

The step of heating and pressing may be performed by a continuous press.

The step of heating and pressing may be performed by a static press.

The pressure applied in the heating and pressing step may be at least 5 bar, such as at least 25 bar, preferably about 30-60 bar, or about 35-55 bar. The pressure may be applied during at least 10 s, preferably during 20-40 s. The temperature applied in the heating and pressing step may be 100-250° C., such as 160-220° C., or 120-170° C. A temperature of at least 120° C., such as at least 150° C., such as at least 180° C., may be applied. The temperature may depend on which binder is used. Also, the temperature may depend on the speed of the production line in a continuous press or the press time of a static press. A lower pressing temperature may be used in the presently disclosed method, using a NAF binder, compared to a method wherein a traditional melamine-formaldehyde binder is used. A lower pressing temperature decreases the risk of steam explosion within the board during pressing. A lower pressing temperature may thus facilitate the use of substrates with a lower internal bond strength. A lower pressing temperature may contribute to making it possible to use substrates with a lower internal bond strength in a method for producing building panels.

The front layer of the building panel produced according to the presently disclosed method may be a decorative, upper layer of the building panel. The front layer may constitute an uppermost layer of the building panel.

After the step of heating and pressing, the building panel may be surface treated, such as with a UV-coating system, with an electron beam (EB) coating system, a single component lacquer system and/or a two-component lacquer system. The building panel may be surface treated on a front surface of the building panel and/or on a back surface of the building panel.

According to one embodiment, the method may additionally comprise a step of applying a veneer layer on a front surface of the front layer, opposite the surface of the front layer facing the substrate and thereafter applying heat and pressure to the veneer layer, the front layer, and the substrate, thereby at least partially curing the front layer to form said building panel. The veneer layer may be a wood veneer layer. The veneer layer may have a thickness of about 0.2-2.0 mm. The veneer layer may comprise open features such as holes and cracks. The method may comprise applying a front veneer layer on a front surface of the front layer, without applying any backing layer. Alternatively, a backing layer may be provided on a back side of the substrate, opposite the front layer, and a backing veneer layer may be applied on the backing layer.

The building panel produced according to the presently disclosed method may comprise a mechanical locking profile.

The building panel produced with the presently disclosed method may be a no added formaldehyde (NAF) panel and/or a no added melamine (NAM) panel.

In a second aspect of the disclosure, a building panel produced with the method according to the first aspect is provided.

In a third aspect of the disclosure there is provided a building panel. The building panel may preferably be a floor panel, a furniture component, a worktop, a wall panel or a ceiling panel.

The building panel comprises a substrate and a front layer attached to a front surface of the substrate. The front layer comprises a no added formaldehyde (NAF) binder. The NAF binder may preferentially be a thermosetting binder.

The NAF binder of the front layer may additionally be a no added melamine (NAM) binder. This is advantageous as melamine is listed on the candidate list of substances of very high concern under REACH (the European Registration, Evaluation, Authorization and restriction of CHemicals), and the use of it is likely to be restricted in the future.

The front layer may comprise at least 25 wt-% of the NAF binder. The front layer may comprise at least 25%, such as at least 50%, such as at least 60 wt-% of the NAF binder.

The NAF binder of the front layer may comprise one or more of polyester, unsaturated polyester, epoxy, polyurethane, acrylate, natural polymers such as lignin, or a combination thereof.

The front layer may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse. The fillers may be inorganic fillers, such as calcium carbonate, barium sulphate, silicon dioxide, kaolin, talc and/or wollastonite.

The front layer may comprise 0-60 wt-%, such as 20-40 wt-% of lignocellulosic materials.

The front layer may comprise 0-75 wt-%, such as 5-25 wt-% of inorganic fillers.

The front layer may comprise 25-100 wt-%, such as 50-100 wt-% or 60-100 wt-% of NAF binder.

The front layer may comprise less than 10 wt-%, such as less than 5 wt-%, less than 1 wt-%, or less than 0.1 wt-% of formaldehyde or a formaldehyde-comprising composition.

The front layer may comprise less than 1 wt-%, such as less than 0.1 wt-% of melamine.

The front layer may be substantially free from formaldehyde.

The front layer may be substantially free from melamine.

The front layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The substrate may be a wood-based board, such as a low density fiberboard (LDF), a medium density fiberboard (MDF), a high density fiberboard (HDF), a plywood, a chipboard, an oriented strand board (OSB), a particle board, a hardboard, a softboard, a wood plastic composite panel (WPC) or combinations thereof.

The substrate may be a no added formaldehyde (NAF) substrate and/or a no added melamine (NAM) substrate.

The substrate of the building panel provided according to above may comprise at least 50 wt-%, such as at least 80 wt-% of recycled material, such as recycled wood, recycled wood waste, recycled cardboard, recycled paper and/or recycled textile. The substrate may comprise 50-100 wt-% of recycled material. By incorporating a substrate comprising recycled material, the sustainability of the building panel as presented above is increased, compared to conventional building panels. The building panel as presented above may have a lower carbon footprint compared to conventional building panels. A building panel comprising a substrate comprising recycled material may have a lower internal bond strength than conventionally produced building panels.

According to one example, the substrate of the presently disclosed building panel may comprise at least 30 wt-%, such as at least 50 wt-% of virgin, biobased material, such as virgin lignocellulosic material and/or virgin textile material. The substrate may comprise 30-100 wt-% of virgin, biobased material. Virgin, biobased material may contribute to improving the sustainability of the building panel as presented above. For example, virgin biobased material that do not fulfil certain quality parameters, like color, to be used for example within the textile industry, may instead be used as raw material in a building panel. A substrate comprising virgin, biobased material may have a lower internal bond strength than substrates conventionally used in building panels.

The substrate of the presently disclosed building panel may have an internal bond strength of 0.2-2.5 N/mm², such as 0.2-2.0 N/mm², such as 0.5-1.5 N/mm², wherein internal bond strength is measured in accordance with EN319. The internal bond strength of such substrates may be too low to enable the use of a traditional melamine-formaldehyde binder in an applied front layer. If a front layer comprising a melamine-formaldehyde binder would be applied on such a substrate, the building panel may be deformed due to contraction forces induced when the melamine-formaldehyde binder cures. Further on, water formed when a melamine-formaldehyde binder cures may generate blisters, or even steam explosions, that can damage the substrate.

Substrates with an even lower internal bond strength, such as a bond strength of −1.0, such as 0.1-0.5 N/mm², wherein internal bond strength is measured in accordance with EN319, may be used in the presently disclosed building panel, for example in building panels like furniture components, such as components for shelves or kitchen cabinets. It may be difficult to form a mechanical locking profile in a building panel with such a low internal bond strength. Such building panels may instead be attached to an underlying surface by for example gluing or stapling.

The building panel may further comprise a paper layer attached to the front layer. The paper layer has preferably been at least partly impregnated with the NAF binder of the front layer. The paper layer may comprise a decorative paper. The paper layer may comprise a print, such as a digital print or an analog print, such as of a wood grain pattern.

In one example, the method further comprises applying a surface layer on the paper layer and thereafter applying heat and pressure to the surface layer, the paper layer, the front layer and the substrate, to form a laminated building panel. The surface layer may preferentially comprise a NAF binder.

Known laminated building panels produced with a front layer comprising melamine-formaldehyde resin, requires a backing layer or balancing layer, provided on a surface of the substrate being opposite the surface on which the front layer is provided. The melamine-formaldehyde results in shrinkage, or pulling, forces acting on the building panel. Without the balancing layer, the product may be “cupping”, i.e., a first surface of the panel will shrink, the opposite surface will stretch correspondingly, resulting in a building panel with a concave cross section. Thus, a balancing layer is required to stabilize and/or balance the building panel to counteract those types of forces.

In order to provide balance, the balancing layer may preferably comprise the same layers as provided on the opposite side of the substrate, at least preferably comprise the same binder as provided on the opposite side of the substrate. When a panel is balanced by applying a balancing layer, internal tension may be created in the panel as the two surfaces of the panel are subject to contraction forces working in opposite directions. These internal tensions may even cause cracks in or delamination of the substrate.

In the presently disclosed building panel, possible contraction forces due to the front layer may be too small to require balance in the form of a balancing or backing layer.

The building panel may not comprise (be free of) a backing layer arranged on a back surface of the substrate opposite the front surface on which the front layer is applied.

Alternatively, the building panel may comprise a backing layer arranged on a back surface of the substrate, opposite from the first surface on which the front layer is arranged.

The backing layer may be included for informational, aesthetic, or decorative purposes. The backing layer may be configured to form a moisture barrier. A backing layer configured to form a moisture barrier may comprise e.g. a thin layer such as a lacquer, a varnish, an adhesive, a polymer-based sheet or foil, an impregnated paper or a powder layer.

The backing layer preferably comprises a NAF binder, such as a thermosetting NAF binder and/or a thermoplastic NAF binder. The NAF binder may be at least partially cured in the finished building panel. The NAF binder of the backing layer may comprise one or more of polyester, unsaturated polyester, epoxy, acrylate, natural polymers such as lignin, polyolefins, acrylates, methacrylates, styrenics, vinylacetates, vinyl alcohols, thermoplastic urethanes or a combination thereof. A thermosetting NAF binder and a thermoplastic NAF binder may form a semi-interpenetrating network (semi-IPN).

The NAF binder of the backing layer may additionally be a no added melamine (NAM) binder.

The backing layer may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The wood fibers may be virgin fibers. The lignocellulosic materials may also be one or more of hemp, grass, flax, straw and/or bagasse. The fillers may be inorganic fillers, such as calcium carbonate, barium sulphate and/or silicon dioxide.

The backing layer may comprise 0-60 wt-%, such as 20-40 wt-% of lignocellulosic materials.

The backing layer may comprise 0-75 wt-%, such as 2-25 wt-% of inorganic fillers,

The backing layer may comprise 25-100 wt-%, such as 50-100 wt-% or 60-100 wt-% of NAF binder.

The backing layer may comprise less than 10 wt-%, such as less than 5 wt-%, less than 1 wt-%, or less than 0.1 wt-% of formaldehyde or a formaldehyde-comprising composition.

The backing layer may comprise less than 1 wt-%, or less than 0.1 wt-% of melamine.

The backing layer may be substantially free from formaldehyde.

The backing layer may be substantially free from melamine.

The front layer of the presently disclosed building panel may be a decorative, upper layer of the building panel. The front layer may constitute an uppermost layer of the building panel, for example an uppermost layer of a floor panel.

The building panel may comprise a surface treatment such as treatment with a UV-coating system, with an electron beam (EB) coating system, with a single component lacquer system and/or with a two-component lacquer system. The building panel may be surface treated on a front surface of the building panel and/or on a back surface of the building panel.

In one embodiment, the building panel additionally comprises a front veneer layer on a front surface of the front layer, opposite the substrate. The front veneer layer may be a wood veneer layer. The front veneer layer may have a thickness of about 0.2-2.0 mm. The front veneer layer may comprise open features such as holes and cracks. The building panel may comprise a front veneer layer on a front surface of the front layer, without any backing layer. Alternatively, the building panel may comprise a backing layer on a back side of the substrate, opposite the front layer, and a backing veneer layer on the backing layer.

The presently disclosed building panel may comprise a mechanical locking profile.

The presently disclosed building panel may be a no added formaldehyde (NAF) panel and/or a no added melamine (NAM) panel.

### BRIEF DESCRIPTION OF THE DRAWINGS

The present disclosure will by way of example be described in more detail with reference to the appended schematic drawings, which show embodiments of the present disclosure.

FIG. 1 shows a method for producing a building panel according to an embodiment of the present disclosure.

FIG. 2 shows a method for producing a building panel according to another embodiment of the present disclosure.

FIG. 3 shows a method for producing a building panel according to yet another embodiment of the present disclosure.

FIG. 4 shows a method for producing a building panel according to yet another embodiment of the present disclosure.

FIG. 5 is a building panel according to an embodiment of the present disclosure.

FIG. 6 is a building panel according to another embodiment of the present disclosure.

FIG. 7 is a building panel according to yet another embodiment of the present disclosure.

FIG. 8 is a building panel according to yet another embodiment of the present disclosure.

FIG. 9 shows a cross-sectional side view of a building panel according to the embodiment shown in FIG. 7.

FIG. 10 is an illustration of a top view of a building panel with a mechanical locking device, according to an embodiment of the present disclosure.

FIG. 11 is an illustration of a cross section of a mechanical locking device in an assembled state arranged along opposite edges of two adjacent building panels, according to an embodiment of the present disclosure.

FIG. 12 is a schematic illustration of the measuring points referred to in Example 10, top view of a building panel.

FIG. 13 is a schematic illustration of the measuring points referred to in Example 10, perspective view of a building panel.

FIG. 14 shows a photo of the building panel produced in Example 2.

FIG. 15 shows a photo of the building panel produced in Example 3.

FIG. 16 shows a photo of the building panel produced in Example 4.

FIG. 17 shows a photo of the building panel produced in Example 5.

FIG. 18 shows a photo of the building panel produced in Example 6.

FIG. 19 shows a photo of the building panel produced in Example 7.

FIG. 20 shows a photo of the building panel produced in Example 8.

FIG. 21 shows a photo of the building panel produced in Example 9.

FIG. 22 shows a photo of the building panels produced in Example 12.

Further, in the figures like reference characters designate like or corresponding parts throughout the several figures.

### DETAILED DESCRIPTION OF EMBODIMENTS

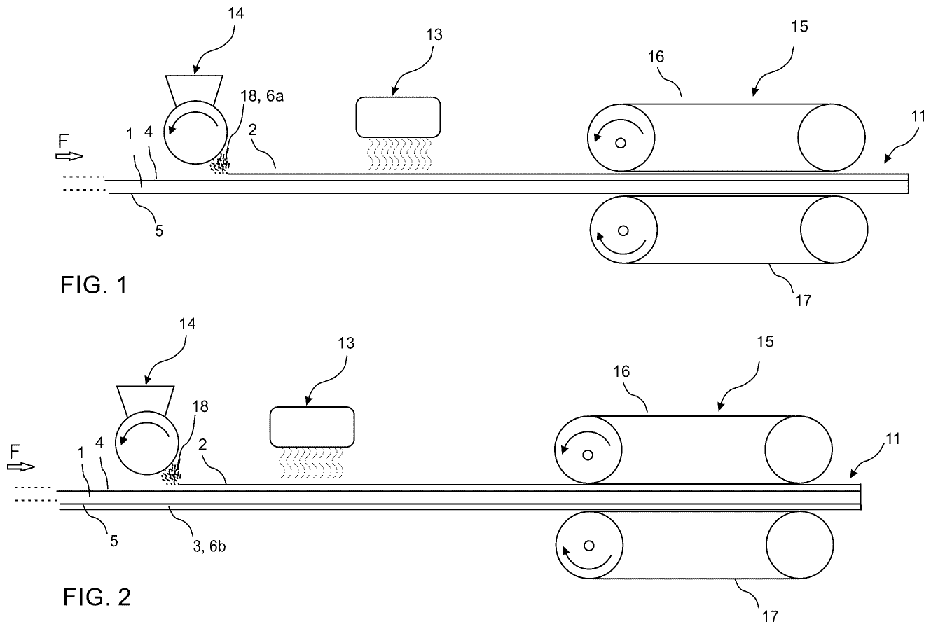

FIG. 1 illustrates an embodiment of a method for producing a building panel 11.

The building panel 11 may be configured to be, or form part of, a furniture component, a building panel such as a floor panel, a ceiling panel, a wall panel, a door panel, a worktop, skirting boards, moldings, edging profiles, etc.

The method includes providing a substrate 1. The substrate 1 is moved in a direction F through a production line comprising several steps, which will be further described below with reference to FIG. 1.

The substrate 1 is preferably a prefabricated substrate, produced prior to the method of producing the panel 11. The substrate 1 may be a board, for example, a wood-based board. The wood-based board may be a low density fiberboard (LDF), a medium density fiberboard (MDF), a high density fiberboard (HDF), a plywood, a chipboard, an oriented strand board (OSB), a particle board, a hardboard, a softboard, a wood plastic composite panel (WPC) or any other suitable wood-based board. Boards comprising other materials may also be used.

The substrate 1 may comprise at least 50 wt-%, such as at least 80 wt-% of recycled material. In the scope of the present disclosure, recycled material means post-consumer and/or post-industrial material. The recycled material may be for example recycled wood, recycled wood waste, recycled cardboard, recycled paper and/or recycled textile.

By using a substrate comprising recycled material, the sustainability of the method as presented above may be increased, compared to conventional methods for producing building panels. A substrate 1 comprising recycled material may have a lower internal bond strength than substrates conventionally used for producing building panels.

In one example, the substrate 1 may comprise at least 30 wt-%, such as at least 50 wt-% of virgin, biobased material, such as virgin lignocellulosic material, virgin textile material. Virgin, biobased material may contribute to improving the sustainability of the method as presented above. For example, virgin biobased material that do not fulfil certain quality parameters, like color, to be used for example within the textile industry, may instead be used as raw material in a building panel. A substrate 1 comprising virgin, biobased material may have a lower internal bond strength than substrates conventionally used for producing building panels.

The substrate may have an internal bond strength of 0.2-2.5 N/mm², such as 0.2-2.0 N/mm², such as 0.5-1.5 N/mm², wherein internal bond strength is measured in accordance with EN319.

Substrates with an even lower internal bond strength, such as a bond strength of 0.1-1.0 N/mm², such as 0.1-0.5 N/mm², wherein internal bond strength is measured in accordance with EN319, may be used in the presently disclosed method, for example for producing furniture components, such as components for shelves or kitchen cabinets. It may be difficult to form a mechanical locking profile in a building panel with such a low internal bond strength. Such building panels may instead be attached to an underlying surface by for example gluing or stapling.

The substrate 1 may preferentially be a no added formaldehyde (NAF) substrate and/or a no added melamine (NAM) substrate.

A front layer 2 comprising a no added formaldehyde (NAF) binder 6a is applied on the front surface 4 of the substrate 1. The NAF 6a binder may preferentially be a thermosetting binder. In the embodiment shown in FIG. 1, the front layer 2 is applied in powder form, as a front layer powder 8, by scattering by means of a scattering device 14.

The front layer 2 may alternatively be applied as a sheet, as a granulate, as a liquid, as a spray, as a film or as a melt.

The front layer 2 may comprise at least 25 wt-% of the NAF binder 6a. The front layer 2 may comprise at least 25%, such as at least 50%, such as at least 60 wt-% of the NAF binder 6a.

The front layer 2 may be applied in an amount of 10-1000 g/m², such as 30-600 g/m², such as 100-450 g/m² or 30-450 g/m².

The NAF binder 6a of the front layer 2 may comprise one or more of polyester, unsaturated polyester, epoxy, polyurethane, acrylate, natural polymers such as lignin, or a combination thereof.

The front layer 2 may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN) in the front layer.

The front layer 2 may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse. The fillers may be inorganic fillers such as calcium carbonate, barium sulphate, silicon dioxide, kaolin, talc and/or wollastonite.

The front layer 2 may comprise 0-60%, such as 20-40 wt-% of lignocellulosic materials.

The front layer 2 may comprise 0-75 wt-%, such as 5-25 wt-% of inorganic fillers.

The front layer 2 may comprise 25-100 wt-%, such as 50-100 wt-% or 60-100 wt-% of the NAF binder 6a.

The front layer 2 may comprise less than 10 wt-%, such as less than 5 wt-%, less than 1 wt-%, or less than 0.1 wt-% of formaldehyde or a formaldehyde-comprising composition.

The front layer 2 may comprise less than 1 wt-%, such as less than 0.1 wt-% of melamine.

The front layer 2 may be substantially free from formaldehyde.

The front layer 2 may be substantially free from melamine.

The method may comprise a step of applying heat by means of a heating device 13 to the front layer 2 as shown in FIG. 1. The heat may be applied by any suitable type of heat source, e.g., thermal radiation, such as IR radiation, and/or by microwaves, and/or by hot air. The front layer 2 may be heated without first applying moisture to the front layer 2 or moisture may be applied to the front layer 2 prior to applying heat to the front layer 2. The step of heating the front layer 2 serves to sinter particles of the binder in the front layer 2. For example, the sintered particles may form a contiguous mass. For example, the sintered particles of the front layer 2 may adhere to the substrate 1.

After applying the front layer 2, heat and pressure are applied to the front layer 2 and the substrate 1, thereby at least partially curing the NAF binder 6a of the front layer 2.

Heat and pressure may be applied by a continuous press 15 as shown in FIG. 1 or by a static press (not illustrated). As shown in the FIG. 1, the pressure may be applied by a continuous press 15, having an upper press belt 16 and a lower press belt 17. The pressure applied may be at least 5 bar, such as at least 25 bar, preferably about 30-60 bar, or about 35-55 bar. The pressure may be applied during at least 10 s, preferably during 20-40 s. The press 15 comprising e.g. either hot oil or electrical/induction heat is heated in order to apply heat together with pressure. A temperature of 100-250° C., such as 160-220° C., or 120-170° C. may be applied. A temperature of at least 120° C., such as at least 150° C., such as at least 180° C., may be applied. The temperature may depend on which binder is used. Also, the temperature may depend on the speed of the production line in a continuous press or the press time of a static press.

When applying heat and pressure, the thermosetting, NAF binder 6a of the front layer 2 is at least partially cured to form a building panel 11. The thermosetting, NAF binder 6a of the front layer may be at least partially cross-linked.

The NAF binder 6a may optionally be further cured by radiation, such as by UV-radiation or by a combination of heat and radiation. NAF binders further cured by radiation may for example be acrylates and/or methacrylates.

The front layer 2 may form an uppermost surface of the finished building panel 11. After the step of heating and pressing the building panel 11 may be surface treated. A coating, such as a UV-coating, an electron beam (EB) coating, a single component lacquer system and/or a two-component lacquer system may be applied on a front surface of the front layer 2 and/or on the back surface 5 of the substrate 1.

The NAF binder 6a of the front layer may preferentially also be a no added melamine (NAM) binder. The front layer 2 preferentially comprises no added formaldehyde and no added melamine, and therefore possible pulling forces due to the front layer may be too small to require balance in the form of a balancing or backing layer. In the embodiment illustrated in FIG. 1, the building panel 11 does not comprise (is free from) any backing layer.

FIG. 2 illustrates an embodiment of the method according to the present disclosure. In the embodiment illustrated in FIG. 2, the method further comprises applying a backing layer 3 to a back surface 5 of the substrate 1, opposite the front surface 4 on which the front layer 2 is applied and thereafter applying heat and pressure to the front layer 2, the substrate 1 and the backing layer 3, to form the building panel 11, as illustrated in FIG. 2. For practical reasons, the backing layer 3 is preferably applied to the back surface 5 of the substrate 1 in a step occurring before the application of the front layer 2. Heat and optionally also moisture may be applied to the backing layer 3 to sinter the particles of the backing layer 3. When the backing layer 3 has been applied to the substrate 1, the substrate 1 and the backing layer 3 are turned, whereafter the front layer 2 is applied on a front surface 4 of the substrate 1, as illustrated in FIG. 2. Turning the substrate 1 and the backing layer 3 is preferably done automatically.

The backing layer 3 may be provided for informational, aesthetic, or decorative purposes.

The backing layer 3 may be configured to form a moisture barrier. This is advantageous when the building panel is used as a floor panel and/or a building panel. Moisture from the base or foundation, such as a concrete ground, on which the building panel is applied may be transferred into the building panel. This may cause swelling of the building panel which may result in a deformed building panel. If the amount of swelling differs between the first and second surfaces of the building panel, the panel will be concave in cross section, i.e. the building panel will experience cupping. By applying e.g. a backing layer forming a moisture barrier, the transfer of moisture into the building panel causing swelling is limited. A backing layer configured to form a moisture barrier may comprise e.g. a thin layer such as a lacquer, a varnish, an adhesive, a polymer-based sheet or foil, an impregnated paper or a powder layer.

The backing layer 3 preferably comprises a NAF binder 6b, such as a thermosetting NAF binder or a thermoplastic NAF binder. The NAF binder 6b of the backing layer 3 may comprise one or more of polyester, unsaturated polyester, epoxy, acrylate, natural polymers such as lignin, polyolefins, acrylates, methacrylates, styrenics, vinylacetates, vinyl alcohols, thermoplastic urethanes or a combination thereof.

A thermosetting NAF binder and a thermoplastic NAF binder may form a semi-interpenetrating network (semi-IPN).

The NAF binder 6b of the backing layer 3 may additionally be a no added melamine (NAM) binder.

The backing layer 3 may comprise one or more of fillers, pigments, wear-resistant particles, lignocellulosic materials, such as wood fibers, and other additives. The wood fibers may preferably be made from recycled wood or wood waste. The wood fibers may come from post-consumer material, such as furniture, flooring or building elements. The wood waste may come from various wood handling processes such as furniture, flooring, or building production processes. The lignocellulosic materials may also be one or more of hemp, grass, flax, straw and/or bagasse.

The backing layer 3 may comprise 0-60 wt-%, such as 20-40 wt-% of lignocellulosic materials.

The backing layer 3 may comprise 0-75 wt-%, such as 5-25 wt-% of inorganic fillers.

The backing layer 3 may comprise 25-100 wt-%, such as 50-100 wt-% or 60-100 wt-% of a NAF binder 6b.

The backing layer 3 may comprise less than 10 wt-%, such as less than 5 wt-%, less than 1 wt-%, or less than 0.1 wt-% of formaldehyde or a formaldehyde-comprising composition.

The backing layer 3 may comprise less than 1 wt-%, such as less than 0.1 wt-% of melamine.

The backing layer 3 may be substantially free from formaldehyde.

The backing layer 3 may be substantially free from melamine.

The NAF binder 6a of the front layer 2 and/or the NAF binder 6b of the backing layer 3 may preferentially be a thermosetting binder, but the skilled artisan will appreciate that other binders, such as thermoplastic binders, are equally conceivable.

If a backing layer 3 is applied to a back surface 5 of the substrate 1, heat and pressure is applied to the front layer 2, the substrate 1 and the backing layer 3 to form a building panel 11.

The step of heating and pressing may be performed by a continuous press.

The step of heating and pressing may be performed by a static press.

The pressure applied in the heating and pressing step may be at least 5 bar, such as at least 25 bar, preferably about 30-60 bar, or about 35-55 bar. The pressure may be applied during at least 10 s, preferably during 20-40 s. The temperature applied in the heating and pressing step may be 100-250° C., such as 160-220° C., or 120-170° C. A temperature of at least 120° C., such as at least 150° C., such as at least 180° C., may be applied. The temperature may depend on which binder is used. Also, the temperature may depend on the speed of the production line in a continuous press or the press time of a static press.

The building panel 11 produced with the method according to the embodiment illustrated in FIG. 2 is preferentially a no added formaldehyde (NAF) panel and/or a no added melamine (NAM) panel.

After the step of heating and pressing the building panel 11 may be surface treated. A coating, such as a UV-coating, an electron beam (EB) coating, a single component lacquer system and/or a two-component lacquer system may be applied on a front surface of the front layer 2 and/or on a back surface of the backing layer 3, opposite the substrate 1.

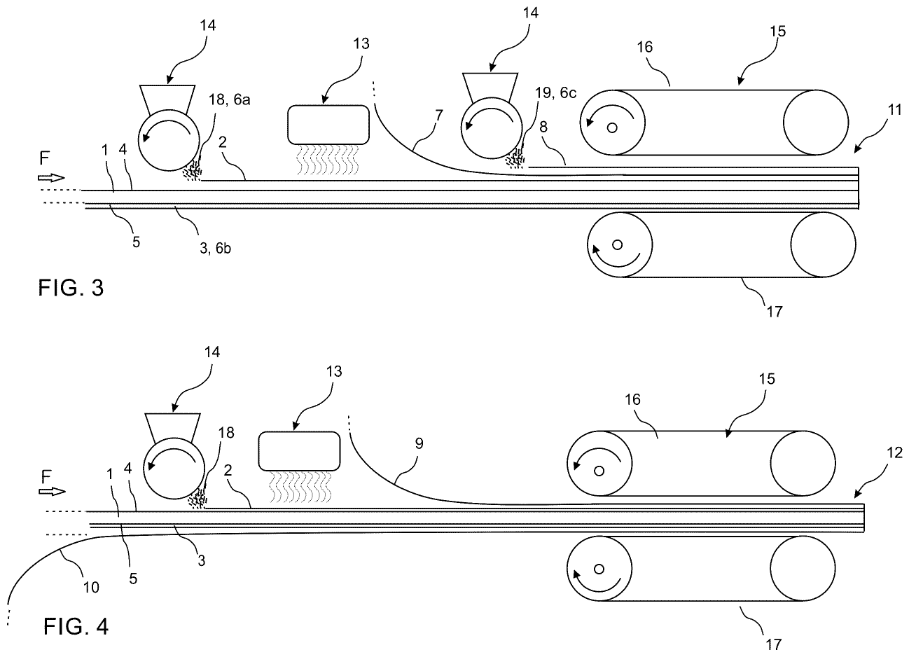

FIG. 3 illustrates an embodiment of a method according to the present disclosure. In the embodiment illustrated in FIG. 3, the method further comprises applying a paper layer 7 on the front layer 2, wherein the paper layer 7 may be essentially unimpregnated when applied on said front layer 2, and thereafter applying heat and pressure to the paper layer 7, the front layer 2 and the substrate 1, to form a building panel 11. The step of applying heat and pressure to the paper layer 3, the front layer 2 and the substrate 1 preferentially comprises at least partly impregnating the paper layer 3 with the NAF binder 6a of the front layer 2, and at least partly curing the NAF binder 6a of the front layer. The paper layer 7 may comprise a decorative paper. The paper layer 7 may comprise a print, such as a digital print or an analog print, such as of a wood grain pattern.

The method according to the embodiment illustrated in FIG. 3 may optionally comprise applying a backing layer 3 to a back surface 5 of the substrate 1, opposite the first surface 4 on which the front layer 2 is applied and thereafter applying heat and pressure to the paper layer 7, the front layer 2, the substrate 1 and the backing layer 3, to form the building panel 11, as illustrated in FIG. 2.

In one example, the method further comprises applying a surface layer 8 on the paper layer 7 and thereafter applying heat and pressure to the surface layer 8, the paper layer 7, the front layer 2 and the substrate 1, to form a building panel 11. The surface layer 8 may preferentially comprise a NAF binder 6c, such as a thermosetting NAF binder or a thermoplastic NAF binder. In the embodiment shown in FIG. 3, the surface layer 8 is applied in powder form, as a surface layer powder 19, by scattering by means of a scattering device 14.

The surface layer 8 may alternatively be applied as a sheet, as a granulate, as a liquid, as a spray, as a film or as a melt.

FIG. 4 illustrates an embodiment of a method according to the present disclosure. In the embodiment illustrated in FIG. 4, the method additionally comprises a step of applying a front veneer layer 9 on a front surface of the front layer 2, opposite the substrate 1, and thereafter applying heat and pressure to the front veneer layer 9, the front layer 2, and the substrate 1, thereby at least partially curing the NAF binder 6a of the front layer 2 to form a veneered building panel 12.

The method may comprise applying a front veneer layer 9 on the front layer 2, without applying any backing layer. Alternatively, a backing layer 3 may be applied on a back surface 5 of the substrate, and a backing layer veneer 10 may be provided on the backing layer 3.

The front layer veneer 9 and/or the backing layer veneer 10 may be a wood veneer layer. The front layer veneer 9 and/or the backing layer veneer 10 may have a thickness of about 0.2-2.0 mm. The front layer veneer 9 and/or the backing layer veneer 10 may comprise open features such as holes and cracks.

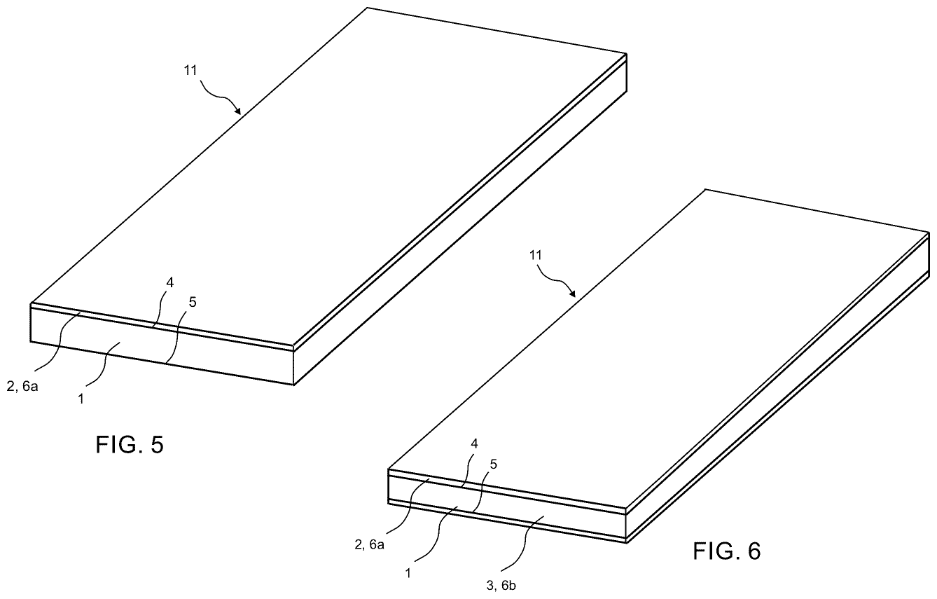

After pressing, a building panel is formed. The building panel includes a substrate 1 and a front layer 2, optionally a backing layer 3, optionally a paper layer 7, optionally a surface layer 8, optionally a front veneer layer 9 and optionally a backing layer veneer 10. Different types of pressed building panels 11 and 12 are schematically illustrated in FIGS. 5-8

The building panels 11 and 12 may be processed from a larger panel board (not illustrated), e.g. by cutting the larger panel board into individual building panels.

The building panels 11 and 12 may be provided with a mechanical locking system.

The building panels 11 and 12 may be a floor panel, a furniture component, a worktop, a wall panel, a ceiling panel or similar.

The building panels 11 and 12 may be classified as a laminate panel according to EN13329.

The building panels 11 and 12 may be classified as a modular mechanical locked floor covering (MMF) according to EN16511.

The veneered building panel 12 may be classified as a veneered building panel according to EN14354.

FIG. 5 shows a building panel 11 comprising a substrate 1 and a front layer 2 arranged on a front surface 4 of the substrate 1.

The substrate 1 may be a wood-based board, such as a low density fiberboard (LDF), a medium density fiberboard (MDF), a high density fiberboard (HDF), a plywood, a chipboard, an oriented strand board (OSB), a particle board, a hardboard, a softboard, a wood plastic composite panel (WPC) or combinations thereof.

The substrate 1 may be a no added formaldehyde (NAF) substrate and/or a no added melamine (NAM) substrate.

The substrate 1 of the building panel 11 may comprise at least 50 wt-%, such as at least 80 wt-% of recycled material, such as recycled wood, recycled wood waste, recycled cardboard, recycled paper and/or recycled textile. By incorporating a substrate comprising recycled material, the sustainability of the building panel 11 may be increased, compared to conventional building panels. The building panel 11 may have a lower carbon footprint compared to conventional building panels.

In one example, the substrate 1 may comprise at least 30 wt-%, such as at least 50 wt-% of virgin, biobased material, such as virgin lignocellulosic material and/or virgin textile material. Virgin, biobased material may contribute to improving the sustainability of the method as presented above. For example, virgin biobased material that do not fulfil certain quality parameters, like color, to be used for example within the textile industry, may instead be used as raw material in a building panel. A substrate 1 comprising virgin, biobased material may have a lower internal bond strength than substrates conventionally used for producing building panels.

The substrate 1 of the presently disclosed building panel may have an internal bond strength of 0.2-2.5 N/mm², such as 0.2-2.0 N/mm², such as 0.5-1.5 N/mm², wherein internal bond strength is measured in accordance with EN319. Substrates with an even lower internal bond strength, such as an internal bond strength of 0.1-1.0, such as 0.1-0.5 N/mm², wherein internal bond strength is measured in accordance with EN319, may be used in the presently disclosed building panel. Such substrates may, for example, be used in building panels like furniture components, such as components for shelves or kitchen cabinets. It may be difficult to form a mechanical locking profile in a building panel with such a low internal bond strength. Such building panels may instead be attached to an underlying surface by for example gluing or stapling.

The front layer 2 comprises a thermosetting, no added formaldehyde (NAF) binder 6a.

The NAF binder 6a of the front layer may additionally be a no added melamine (NAM) binder. This is advantageous as melamine is listed on the candidate list under REACH (the European registration, evaluation, authorization and restriction of chemicals), and the use of it is likely to be restricted in the future.

The front layer 2 may comprise at least 25 wt-% of the NAF binder 6a. The front layer 2 may comprise at least 25%, such as at least 50%, such as at least 60 wt-% of the NAF binder 6a.

The NAF binder 6a of the front layer 2 may comprise one or more of polyester, unsaturated polyester, epoxy, polyurethane, acrylate, natural polymers such as lignin, or a combination thereof.

The front layer 2 may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse. The fillers may be inorganic fillers, such as calcium carbonate, barium sulphate, silicon dioxide, kaolin, talc and/or wollastonite.

The front layer 2 may comprise 0-60 wt-%, such as 20-40 wt-% of lignocellulosic materials.

The front layer 2 may comprise 0-75 wt-%, such as 5-25 wt-% of inorganic fillers.

The front layer 2 may comprise 25-100 wt-%, such as 50-100 wt-% or 60-100 wt-% of the NAF binder 6a.

The front layer 2 may comprise less than 10 wt-%, such as less than 5 wt-%, less than 1 wt-%, or less than 0.1 wt-% of formaldehyde or a formaldehyde-comprising composition.

The front layer 2 may comprise less than 1 wt-%, such as less than 0.1 wt-% of melamine.

The front layer 2 may be substantially free from formaldehyde.

The front layer 2 may be substantially free from melamine.

The front layer 2 may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The front layer 2 preferentially comprises no added formaldehyde and no added melamine, and therefore possible pulling forces due to the front layer 2 may be too small to require balance in the form of a balancing or backing layer. In the embodiment illustrated in FIG. 5, the building panel 11 does not comprise any backing layer.

In one embodiment of the disclosure, the building panel 11 may additionally comprise a backing layer 3, arranged on a back surface 5 of the substrate 1, opposite from the first surface 4 on which the front layer 2 is arranged. This embodiment is shown in FIG. 6. The backing layer 3 may comprise a NAF binder 6b, such as a thermosetting NAF binder and/or a thermoplastic NAF binder. The NAF binder 6b of the backing layer 3 may be at least partially cured.

The NAF binder 6b of the backing layer 3 may additionally be a no added melamine (NAM) binder. This is advantageous as melamine is listed on the candidate list under REACH (the European registration, evaluation, authorization and restriction of chemicals), and the use of it is likely to be restricted in the future.

The backing layer 3 may comprise at least 25 wt-% of the NAF binder 6b. The backing layer 3 may comprise at least 25%, such as at least 50%, such as at least 60 wt-% of the NAF binder 6b.

The NAF binder 6b of the backing layer 3 may comprise one or more of polyester, unsaturated polyester, epoxy, polyurethane, acrylate, natural polymers such as lignin, polyolefins, acrylates, methacrylates, styrenics, vinylacetates, vinyl alcohols, thermoplastic urethanes or a combination thereof. A thermosetting NAF binder and a thermoplastic NAF binder may form a semi-interpenetrating network (semi-IPN).

The backing layer 3 may comprise one or more of fillers, pigments, wear-resistant particles, lignocellulosic materials, such as wood fibers, and other additives. The wood fibers may preferably be made from recycled wood or wood waste. The wood fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse. The fillers may be inorganic fillers, such as calcium carbonate, barium sulphate, silicon dioxide, kaolin, talc and/or wollastonite.

The backing layer 3 may comprise 0-60 wt-%, such as 20-40 wt-% of lignocellulosic materials.

The backing layer 3 may comprise 0-75 wt-%, such as 5-25 wt-% of inorganic fillers.

The backing layer 3 may comprise 25-100 wt-%, such as 50-100 wt-% or 60-100 wt-% of the NAF binder 6b.

The backing layer 3 may comprise less than 10 wt-%, such as less than 5 wt-%, less than 1 wt-%, or less than 0.1 wt-% of formaldehyde or a formaldehyde-comprising composition.

The backing layer 3 may comprise less than 1 wt-%, such as less than 0.1 wt-% of melamine.

The backing layer 3 may be substantially free from formaldehyde.

The backing layer 3 may be substantially free from melamine.

The front layer 2 of the building panel 11 may constitute an upper, decorative layer of the building panel. The front layer 2 may constitute an uppermost layer of the building panel 11.

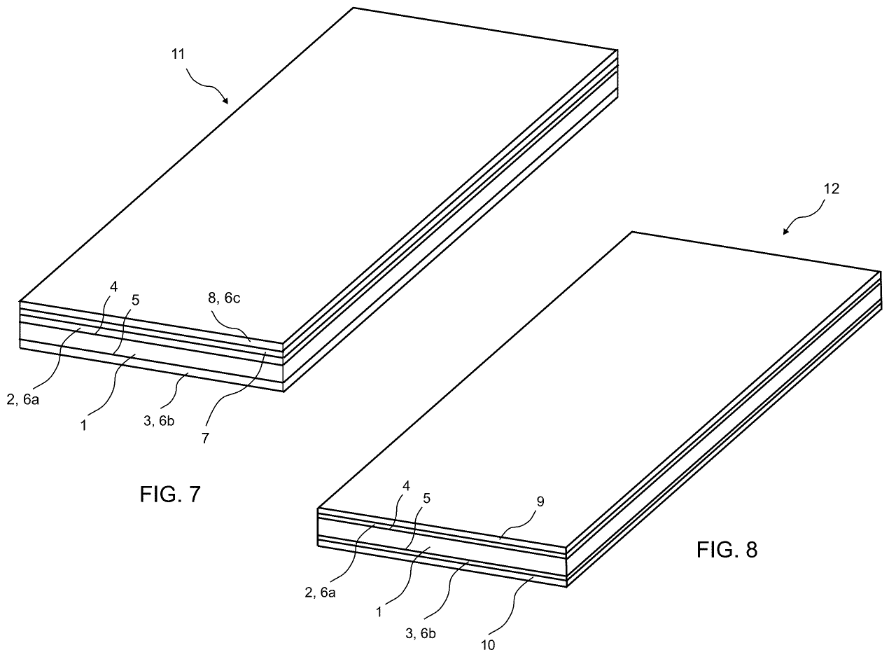

In one embodiment of the disclosure, the building panel 11 may additionally comprise a paper layer 7, attached to the front layer 2. This embodiment is shown in FIG. 7. The paper layer 3 has preferably been at least partly impregnated with the NAF binder 6a of the front layer 2. The paper layer 7 may comprise a decorative paper. The paper layer 7 may comprise a print, such as a digital print or an analog print, such as of a wood grain pattern.

In one example, the building panel further comprises a surface layer 8 attached to the paper layer 7. The surface layer 8 may preferentially comprise a NAF binder 6c, such as a thermosetting NAF binder or a thermoplastic NAF binder.

FIG. 8 shows a veneered building panel 12, according to another embodiment of the present disclosure.

The veneered building panel 12 additionally comprises a front veneer layer 9 arranged on a front side of the front layer 2, opposite the substrate 1. The front veneer layer 9 may be a wood veneer layer. The front veneer layer 9 may have a thickness of about 0.2-2.0 mm. The front veneer layer 9 may comprise open features such as holes and cracks. The veneered building panel 12 may additionally comprise a backing layer 3. Optionally, a backing veneer layer 10 may be arranged on the backing layer 3.

In all the embodiments disclosed herein, the building panel 11, 12 may comprise a surface treatment layer such as a UV-coating, an electron beam (EB) coating, a single component lacquer system and/or a two-component lacquer system on a front surface of the front layer 2, on the front veneer layer 9, on the surface layer 8, on the back surface 5 of the substrate, on a back surface of the backing layer 3 and/or on a back surface of the backing veneer layer 10.

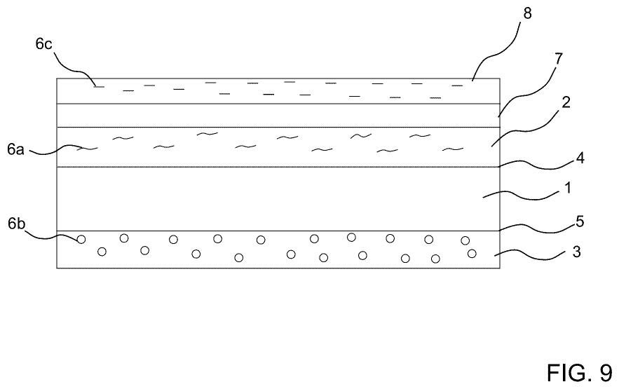

FIG. 9 shows a cross-sectional side view of the building panel 11 according to the embodiment shown in FIG. 7. The building panel 11 comprises a substrate 1, a front layer 2 arranged on a front surface 4 of the substrate 1 and a backing layer 3 arranged on a back surface 5 of the substrate 1, opposite from the front surface 4. The building panel 11 further comprises a paper layer 7 arranged on the front layer 2 and a surface layer 8 arranged on the paper layer 7. The front layer 2 comprises a thermosetting, no added formaldehyde (NAF) binder 6a and the backing layer 3 may comprise a no added formaldehyde (NAF) binder 6b. The surface layer 8 may comprise a no added formaldehyde (NAF) binder 6c.

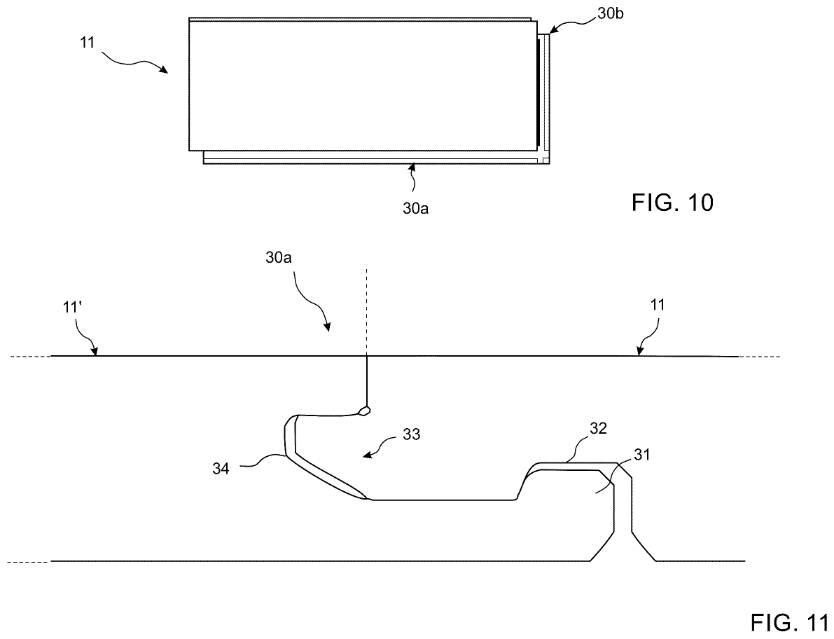

FIG. 10 illustrates a top view of a building panel 11 provided with a first mechanical locking device 30a and a second mechanical locking device 30b, in order to assemble similar or essentially identical building panels.

FIG. 11 is a schematic illustration of the first mechanical locking device 30a in the assembled state of two adjacent building panels 11, 11′. The first mechanical locking device 30a comprises a locking element 31, configured to cooperate with a locking groove 32 for horizontal locking.

The first mechanical locking device 30a further comprises a locking tongue 33, configured to cooperate with a tongue groove 34 for vertical locking.

The embodiments have been described in relation to a continuous press 15 having an upper press belt 16 and a lower press belt 17. In other embodiments, a static press may be used. A static press comprises an upper press plate and a lower press plate.

The invention is further illustrated in the following examples, which do not limit the scope of the invention described in the claims.

### EXAMPLES

Formulations used in the Examples:

TABLE 1
Composition of formulations A and B (wt %)

| Formulation | A | B |
|---|---|---|
| NAF binder (polyester-based) | 62.5 | — |
| MF binder | — | 52.5 |
| Wood powder | 25 | 35 |
| Fillers and pigments | 12.5 | 12.5 |

### Example 1. Measurement of Internal Bond Strength of Four Different Substrates

Internal bond strength was measured for the four different substrates used in Examples 2-9. The substrates tested were a 10 mm HDF panel, a 19 mm MDF panel, a chipboard panel made of recycled wood and biogenic, formaldehyde-free glue (Organic Board Pure P2 RAW from Pfeiderer, approx. 10 mm) and a panel made of recycled cardboard (Recoma, PackWall Design, approx. 13 mm). Internal bond strength was measured in accordance with EN 319. The results are shown in Table 2 below.

TABLE 2
Internal bond strength of different substrates

| Substrate | Internal bond strength (N/mm²) |
|---|---|
| HDF | 2.16 |
| MDF | 0.62 |
| Organic Board | 1.44 |
| Recoma | 0.14 |

### Example 2. Production of a Building Panel Comprising a Front Layer with NAF Binder on an HDF Substrate

A front layer powder comprising formulation A was applied on a 10 mm HDF panel in an amount of 450 g/m². The panel was heat pressed at 180° C. and 50 bar for 30 s. A building panel with a surface coating of the polyester-based NAF binder was formed.

### Example 3. Production of a Building Panel Comprising a Front Layer with Melamine-Formaldehyde (MF) Binder on an HDF Substrate

A front layer powder comprising formulation B was applied on a 10 mm HDF panel in an amount of 450 g/m². Two décor papers impregnated with formulation B were applied to the rear side of the panel, for balancing purposes. This is required when using an MF binder; if the panel is not balanced, the panel will have too much cupping in order to measure dimensional stability on it correctly. The panel was heat pressed at 180° C. and 50 bar for 30 s. A building panel with a surface coating of melamine-formaldehyde binder was formed.

### Example 4. Production of a Building Panel Comprising a Front Layer with NAF Binder on an MDF Substrate

A front layer powder comprising formulation A was applied on a 19 mm MDF panel in an amount of 450 g/m². The panel was heat pressed at 180° C. and 50 bar for 30 s. A building panel with a surface coating of the polyester-based NAF binder was formed.

### Example 5. Production of a Building Panel Comprising a Front Layer with Melamine-Formaldehyde (MF) Binder on an MDF Substrate

A front layer powder comprising formulation B was applied on a 19 mm MDF panel in an amount of 450 g/m². Two décor papers impregnated with formulation B were applied to the rear side of the panel, for balancing purposes. This is required when using an MF binder; if the panel is not balanced, the panel will have too much cupping in order to measure dimensional stability on it correctly. The panel was heat pressed at 180° C. and 50 bar for 30 s. A building panel with a surface coating of melamine-formaldehyde binder was formed.

### Example 6. Production of a Building Panel Comprising a Front Layer with NAF Binder on a Chipboard Panel Made of Recycled Wood

A front layer powder comprising formulation A was applied in an amount of 450 g/m² on a panel made of recycled wood (Organic Board Pure P2 RAW from Pfeiderer, approx. 10 mm). A Walki paper was applied on the rear side. The panel was heat pressed at 160° C. on the front side and 130° C. on the rear side, at 50 bar for 30 s. A building panel with a surface coating of the polyester-based NAF binder was formed.

### Example 7. Production of a Building Panel Comprising a Front Layer with Melamine-Formaldehyde Binder on a Chipboard Panel Made of Recycled Wood

A powder layer comprising formulation B was applied in an amount of 450 g/m² on both sides of a panel made of recycled wood (Organic Board Pure P2 RAW from Pfeiderer, approx. 10 mm). The panel was heat pressed at 180° C. (both sides) and 50 bar for 30 s. A building panel with a surface coating of melamine-formaldehyde binder was formed.

### Example 8. Production of a Building Panel Comprising a Front Layer with NAF Binder on a Substrate Made of Recycled Cardboard

A front layer powder comprising formulation A was applied in an amount of 450 g/m² on a panel made of recycled cardboard (Recoma, PackWall Design, approx. 13 mm). The panel was heat pressed at 180° C. and 50 bar for 30 s. A building panel with a surface coating of the polyester-based NAF binder was formed.

### Example 9. Production of a Building Panel Comprising a Front Layer with Melamine-Formaldehyde Binder on a Substrate Made of Recycled Cardboard

A powder layer comprising formulation B was applied in an amount of 450 g/m² on both sides of a panel made of recycled cardboard (Recoma, PackWall Design, approx. 13 mm). The panel was heat pressed at 180° C. and 50 bar for 30 s. A building panel with a surface coating and a backing coating of melamine-formaldehyde binder was formed.

### Example 10. Cupping/Crowning of Building Panels from Examples 2-9, with a Mechanical Locking Profile, after 72 h Climate Chamber

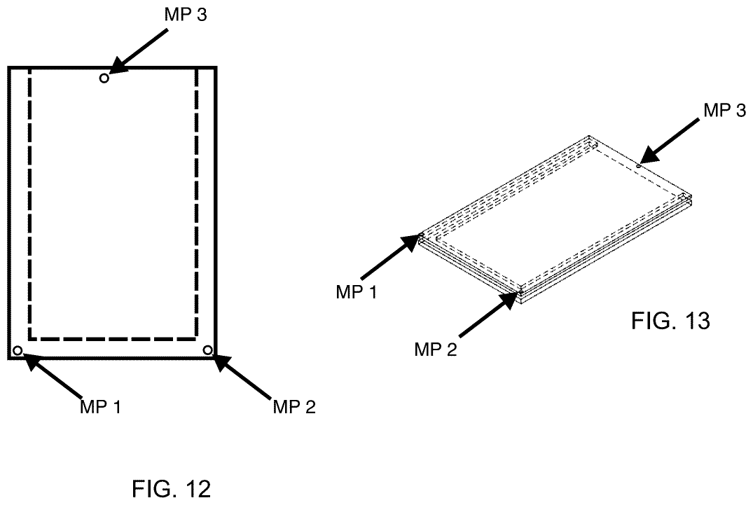

The building panels produced in Examples 2-9 were sawn into tiles of 100×180 mm, and a groove (10 mm deep, 3 mm high and 2.6 mm from the surface) was cut on three sides to simulate a mechanical locking profile. The building panels were placed in a climate chamber at 25° C. and 25% relative humidity for 72 hours. Height measurements were performed on three measuring points on the building panels produced in Examples 2-7 (HDF substrate, MDF substrate and chipboard panel made of recycled wood). The measuring points are schematically illustrated in FIGS. 12 (top view) and FIG. 13 (perspective view). Measuring point 3 is in the middle of the short side of the panel with no groove and represents the reference point. Measuring points 1 and 2 are in the respective outer corners of the short side of the panel with a groove. Height measurements were performed using a flat reference surface plate and a depth gauge. The height differences between measuring point 3 and measuring points 1 and 2 respectively are calculated and can be seen in Table 3 below. The height differences is a measure of the cupping/crowning of the building panels. The building panels produced on a substrate made of recycled cardboard (Examples 8 and 9) had surfaces that were too uneven to enable measuring the height differences correctly. The height measurements on “Organic board” were performed on a different occasion than the height measurements on the HDF substrate and the MDF substrate. Different experimental setups of the measuring equipment on these two occasions resulted in different outcomes with respect to concave/convex height differences from the two measuring occasions. This difference is not relevant in this case, as it is the cupping/crowning of the NAF-panel compared to the MF-panel (for the respective type of substrate) that the experiment should illustrate. It is the absolute numbers of the height difference that shows the cupping/crowning behavior of the panels.

TABLE 3

| | HDF substrate | | MDF substrate | | Organic board | |
|---|---|---|---|---|---|---|
| | NAF | MF | NAF | MF | NAF | MF |
| | binder | binder | binder | binder | binder | binder |
| Height | −0.03 | 0.26 | −0.01 | 0.26 | 0.08 | −0.33 |
| difference | | | | | | |
| MP 1-MP | | | | | | |
| 3 (mm) | | | | | | |
| Height | −0.05 | 0.25 | −0.09 | 0.39 | 0.05 | −0.33 |
| difference | | | | | | |
| MP 2-MP | | | | | | |
| 3 (mm) | | | | | | |

It is seen in Table 3 that the height difference in measuring points 1 and 2 (compared to measuring point 3) are greater for the panels with a melamine-formaldehyde binder in the front layer, compared to the panels with a NAF binder in the front layer, which indicates a stronger cupping/crowning behavior of the panels with a melamine-formaldehyde front layer. This goes for the panels made with an HDF substrate as well as for the panels made with an MDF substrate and the panels made with a chipboard panel made of recycled wood).

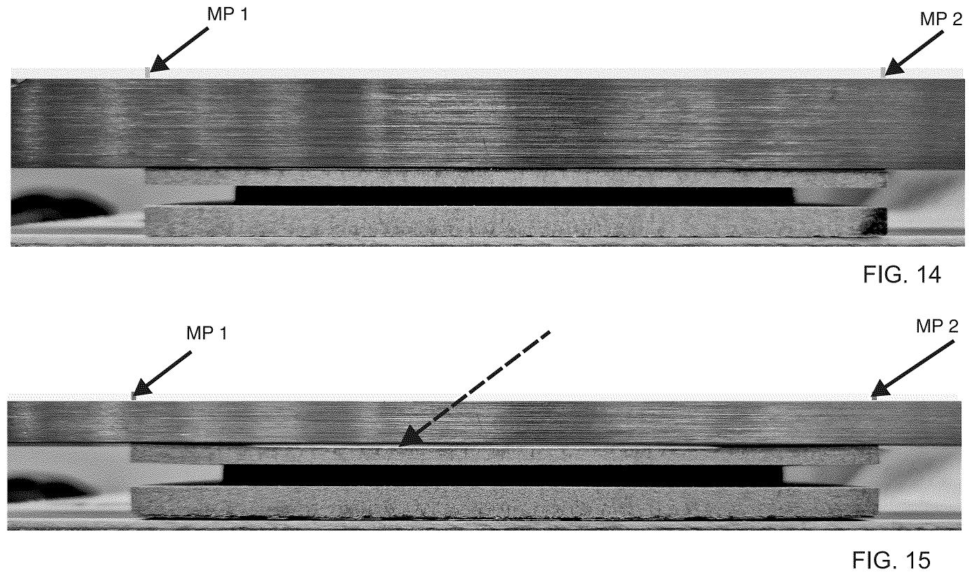

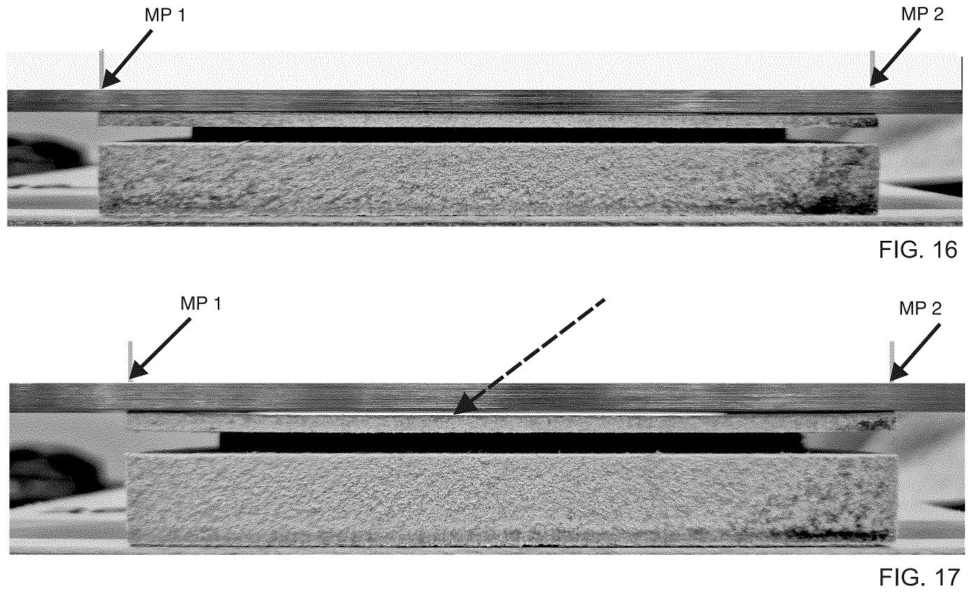

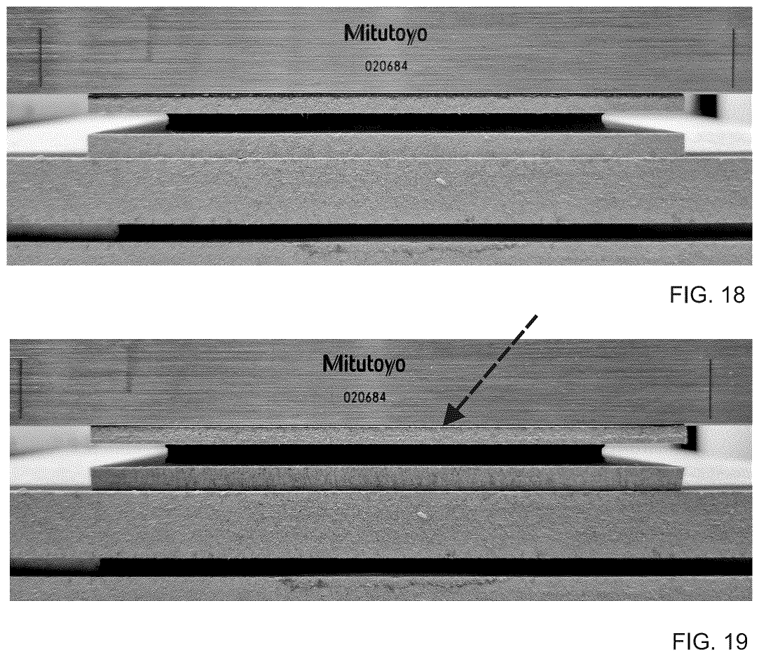

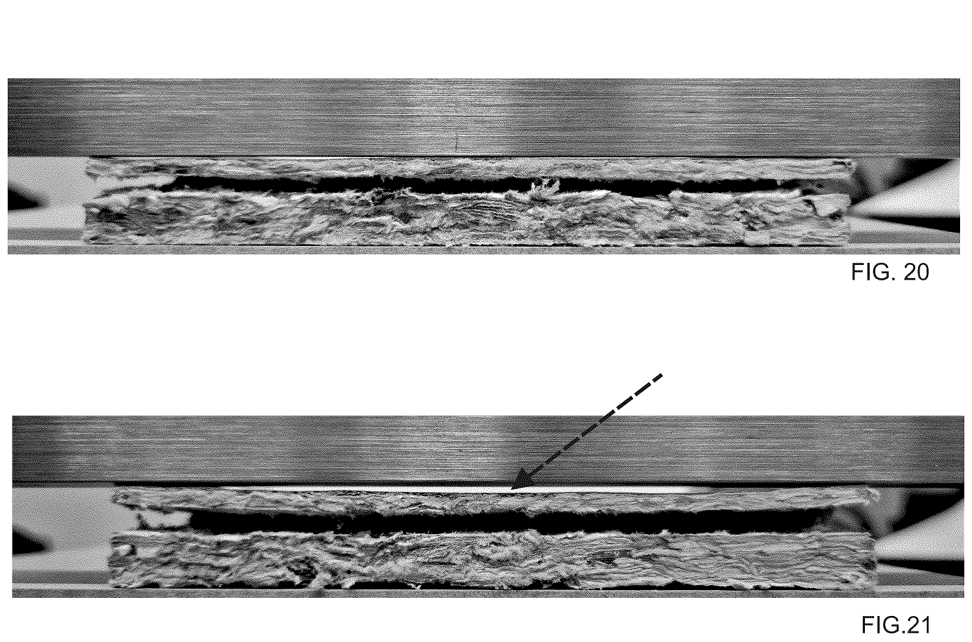

Photos were taken of the different building panels. The photos were taken from the short sides comprising a groove. The photos are shown in FIG. 14 (NAF binder on HDF), FIG. 15 (MF binder on HDF), FIG. 16 (NAF binder on MDF), FIG. 17 (MF binder on MDF), FIG. 18 (NAF binder on chipboard panel made of recycled wood), FIG. 19 (MF binder on chipboard panel made of recycled wood), FIG. 20 (NAF binder on board of recycled cardboard) and FIG. 21 (MF binder on board of recycled cardboard). For the building panels with an HDF substrate and an MDF substrate, the height differences in measuring points 1 and 2 respectively, compared to measuring point 3, are indicated in the photos.

The photos clearly show that the height differences of the building panels with a front layer comprising a melamine-formaldehyde (MF) binder are greater than the height differences of the building panels with a front layer comprising a NAF binder. For the panels made with a front layer comprising an MF binder, the height differences result in a visible air gap between the panel and the measuring equipment. This air gap is marked with a dashed arrow in FIGS. 15, 17 and 19. The air gap is an indication of the elevated risk for damaging, such as rupturing or chipping of these panels. The observed height difference would in an installed floor risk being visible in a way being disturbing to the end consumer or even being higher than the allowed tolerance for the specific product type and market. In addition, the height difference being the result of a change in dimension and shape of the product could cause a stress in the material build up giving rupture due to insufficient internal bond strength of the board or in the case of layered product delamination of layers. As can be seen in the photos, the height differences are largest in the building panel with a core made of recycled cardboard (lowest internal bond strength) and slightly less pronounced, although clearly visible, in the building panel with an HDF core. Hence, the difference in cupping/crowning behavior between a building panel with a NAF front layer and a building panel with an MF front layer is most clearly seen for building panels with a low internal bond strength

### Example 11. Long-Time Stability Test of Building Panels Produced on HDF Substrate and Installed as Floor in a Climate Chamber

Two types of building panels were produced by applying a front layer powder comprising formulations A and B respectively, in an amount of 450 g/m² to two 10 mm HDF boards. To the board with a front layer of formulation B, a backing layer of formulation B was applied to the rear side of the HDF board, for balancing purposes. This is required when using an MF binder; if the panel is not balanced, the panel will have too much cupping in order to measure dimensional stability on it correctly. The boards were heat pressed at 180° C. and 50 bar for 30 s. The boards were sawn into tiles of 380×760×10 mm and profiled to add a mechanical locking system. About 4 m² of each building panel type were installed in a climate chamber and left for 9 weeks. The temperature in the climate chamber was about 22° C. for the whole period, while the relative air humidity (RH) was varied according to below:
Week 1: 50% RH
Week 2-5: 85% RH
Week 6-9: 30% RH

After the 9 weeks in the climate chamber, dimensional changes, height difference, gap change and cupping change of the building panels were measured in accordance with EN17142, and the results are shown in Table 4 below.

TABLE 4

| | Height | | | | | | |
|---|---|---|---|---|---|---|---|
| | difference | | | | | | |
| | change | | Gap change | | Cupping | Dimensional | |
| | Short | Long | Short | Long | Change | change | |
| | side | side | side | side | (% of | Width | Length |
| | (mm) | (mm) | (mm) | (mm) | width) | (mm/m) | (mm/m) |
| A | 0.07 | 0.03 | 0.29 | 0.08 | 0.39 | 1.35 | 0.67 |
| B | 0.07 | 0.13 | 0.15 | 0.20 | 1.07 | 1.80 | 1.34 |

It is shown in Table 4 that the long-term stability when exposed to different climates is better for building panels comprising a front layer of NAF binder, compared to building panels comprising a front layer of melamine-formaldehyde binder.

### Example 12. Initial Surface Contraction of Building Panels with No Backing Layer and No Mechanical Locking Profile

Two building panels were produced by applying a front layer powder comprising formulations A and B respectively, in an amount of 450 g/m² to two 890×980×10 mm HDF boards, creating panel A (comprising powder formulation A) and panel B (comprising powder formulation B). No backing layer was applied in this example, neither to panel A nor panel B.

Panel B was treated with water mist and then both panels were IR-heated and heat pressed at 180° C./130° C. (top/bottom temperature) at 40 bar for 30 s, creating building panel A (with a front layer comprising a NAF binder) and building panel B (with a front layer comprising a melamine-formaldehyde binder). The building panels were left to cool overnight. Their respective bending amplitude was measured by turning the panels upside-down and measuring the distance from the panel surface to the floor at the highest point, using a caliper. Note that some bending is induced in this experiment by having a higher temperature on the front side during pressing, which will dry the front surface more than the backside, thus very slightly bending the board concave. The bending amplitude for the two building panels is shown in Table 5 below.

TABLE 5

| Building panel | A | B |
|---|---|---|
| Bending amplitude (mm) | 3.19 (concave) | 24.87 (concave) |

The amplitude of the bending (cupping) relates to the amount of surface tension created during curing. It is clear from the results in Table 5 that binder formulation B induces considerably more surface tension in the building panel than formulation A and, consequently, the building panel with a front layer comprising formulation B is more bent.

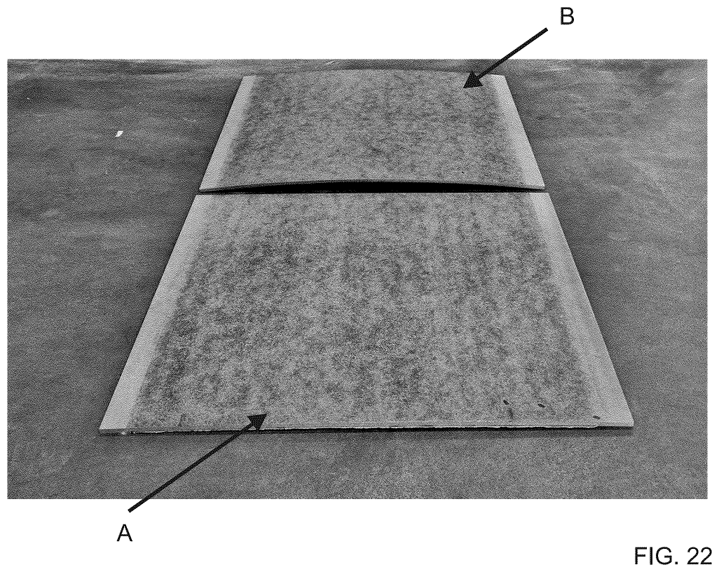

A photo showing the building panels A and B (in perspective view) was taken and is shown in FIG. 22. Building panel A and building panel B are indicated in the photo. As can be seen, building panel B is considerably bent (concave cupping) whilst building panel A is essentially flat. This shows that the melamine-formaldehyde binder induces much more tension in the building panel than the NAF binder does.

### ITEMS

1. A method for producing a building panel comprising:
providing a substrate (1),
applying a front layer (2) comprising a no added formaldehyde (NAF) binder (6a) on a front surface (4) of the substrate (1), wherein said NAF binder (6a) is a thermosetting binder, and
thereafter applying heat and pressure to the front layer (2) and the substrate (1), thereby at least partially curing the NAF binder (6a) of the front layer (2), to form said building panel.

2. The method according to item 1, wherein the front layer (2) comprises at least 25 wt-% of said NAF binder (6a).

3. The method according to item 1 or 2, wherein the NAF binder (6a) of the front layer (2) comprises one or more of polyester, unsaturated polyester, epoxy, polyurethane, acrylate, natural polymers such as lignin, or a combination thereof.

4. The method according to any of the preceding items, wherein the front layer (2) comprises one or more of fillers, pigments, wear-resistant particles, lignocellulosic materials, such as wood fibers, and other additives.

5. The method according to any of the preceding items, wherein the front layer (2) is applied in powder form or as a granulate.

6. The method according to any of the preceding items, wherein the front layer (2) is applied in an amount of 10-1000 g/m², such as 30-600 g/m², such as 100-450 g/m² or 30-100 g/m².

7. The method according to any of the preceding items, wherein the substrate (1) is a wood-based board, such as a low density fiberboard (LDF), a medium density fiberboard (MDF), a high density fiberboard (HDF), a plywood, a chipboard, an oriented strand board (OSB), a particle board, a wood plastic composite panel (WPC) or combinations thereof.

8. The method according to any of the preceding items, wherein the substrate (1) comprises at least 50 wt-%, such as at least 80 wt-% of recycled material, such as recycled wood, recycled wood waste, recycled cardboard, recycled paper and/or recycled textile.

9. The method according to any of the preceding items, wherein the substrate (1) is a no added formaldehyde (NAF) substrate and/or a no added melamine (NAM) substrate.

10. The method according to any of the preceding items, wherein the substrate (1) has an internal bond strength of 0.2-2.5 N/mm², such as 0.2-2.0 N/mm², such as 0.5-1.5 N/mm², wherein internal bond strength is measured in accordance with EN319.

11. The method according to any of the preceding items, further comprising applying a backing layer (3) to a back surface (5) of the substrate (1) opposite the front surface (4) on which the front layer (2) is applied, and
thereafter applying heat and pressure to the front layer (2), the substrate (1) and the backing layer (3), thereby at least partially curing the front layer (2), and the backing layer (3) to form said building panel.

12. The method according to item 11, wherein the backing layer (10) comprises a no added formaldehyde (NAF) binder (6b).

13. The method according to any of the items 1-10, wherein the method does not comprise applying a backing layer to a back surface of the substrate opposite the front surface on which the front layer is applied.

14. The method according to any of the preceding items, wherein the temperature applied in the heating and pressing step is 100-250° C.

15. The method according to any of the preceding items, wherein the pressure applied in the heating and pressing step is at least 25 bar.

16. The method according to any of the preceding items, wherein said building panel is a NAF (no added formaldehyde) panel and/or a NAM (no added melamine) panel.

17. The method according to any of the preceding items, wherein said building panel is a floor panel, a furniture component, a worktop, a wall panel or a ceiling panel.

18. A building panel (11) produced with the method according to any of the items 1-17.

19. A building panel (11), comprising:
a substrate (1), and
a front layer (2) attached to a front surface (4) of the substrate (1),
wherein the front layer (2) comprises a thermosetting, no added formaldehyde (NAF) binder (6a).

20. The building panel according to item 19, wherein the front layer (2) comprises at least 25 wt-% of said NAF binder (6a).

21. The building panel according to item 19 or 20, wherein the NAF binder (6a) of the front layer (2) comprises one or more of polyester, unsaturated polyester, epoxy, polyurethane, acrylate, natural polymers such as lignin, or a combination thereof.

22. The building panel according to any of the items 19-21, wherein the front layer (2) comprises one or more of fillers, pigments, wear-resistant particles, lignocellulosic materials, such as wood fibers, and other additives.

23. The building panel according to any of the items 19-22, wherein the substrate (1) is a wood-based board, such as an MDF board, a HDF board, a low-density fiberboard, a plywood, a chipboard, a particle board, or a wood plastic composite panel (WPC).

24. The building panel according to any of the items 19-23, wherein the substrate (1) comprises at least 50 wt-%, such as at least 80 wt-% of recycled material, such as recycled wood, recycled wood waste, recycled cardboard, recycled paper and/or recycled textile.

25. The building panel according to any of the items 19-24, wherein the substrate (1) is a no added formaldehyde (NAF) and/or a no added melamine (NAM) substrate.

26. The building panel according to any of the items 19-25, wherein the substrate (1) has an internal bond strength of 0.2-2.5 N/mm², such as 0.2-2.0 N/mm², or such as 0.5-1.5 N/mm², wherein internal bond strength is measured in accordance with EN319.

27. The building panel according to any of the items 19-26, wherein said building panel (12) additionally comprises a backing layer (10) arranged on a back surface (5) of the substrate (1), opposite from the first surface (4) on which the sub-layer (2) is arranged.

28. The building panel according to item 27, wherein the backing layer (10) comprises a no added formaldehyde (NAF) binder (6b).

29. The building panel according to any of the items 19-26, wherein said building panel (12) does not comprise a backing layer arranged on a back surface (5) of the substrate (1), opposite from the first surface (4) on which the sub-layer (2) is arranged.

30. The building panel according to any of the items 19-29, wherein said building panel (12) is a no added formaldehyde (NAF) panel and/or a no added melamine (NAM) panel.

31. The building panel according to any of the items 19-30, wherein said building panel is a floor panel, a furniture component, a worktop, a wall panel or a ceiling panel.

1. A method for producing a building panel comprising:
providing a substrate,
applying a front layer comprising a no added formaldehyde (NAF) binder on a front surface of the substrate, wherein said NAF binder is a thermosetting binder, and
thereafter applying heat and pressure to the front layer and the substrate, thereby at least partially curing the NAF binder of the front layer, to form said building panel, wherein the substrate has an internal bond strength of 0.2-2.0 N/mm², such as 0.5-1.5 N/mm², and wherein internal bond strength is measured in accordance with EN319.

2. The method according to claim 1, wherein the front layer comprises at least 25 wt-% of said NAF binder.

3. The method according to claim 1, wherein the NAF binder of the front layer comprises one or more of polyester, unsaturated polyester, epoxy, polyurethane, acrylate, natural polymers, or a combination thereof.

4. The method according to claim 1, wherein the front layer comprises one or more of fillers, pigments, wear-resistant particles, lignocellulosic materials, such as wood fibers, and other additives.

5. The method according to claim 1, wherein the front layer is applied in an amount of 10-1000 g/m².

6. The method according to claim 1, wherein the substrate is a wood-based board.

7. The method according to claim 1, wherein the substrate comprises at least 50 wt-%, such as at least 80 wt-% of recycled material.

8. The method according to claim 1, wherein the substrate comprises at least 30 wt-% of virgin biobased material.

9. The method according to claim 1, wherein the substrate is a no added formaldehyde (NAF) substrate and a no added melamine (NAM) substrate.

10. The method according to claim 1, further comprising applying a backing layer to a back surface of the substrate opposite the front surface on which the front layer is applied, and
thereafter applying heat and pressure to the front layer, the substrate and the backing layer, thereby at least partially curing the front layer, and the backing layer to form said building panel.

11. The method according to claim 10, wherein the backing layer comprises a no added formaldehyde (NAF) binder.

12. The method according to claim 1, wherein the temperature applied in the heating and pressing step is 100-250° C.

13. The method according to claim 1, wherein the pressure applied in the heating and pressing step is at least 5 bar.

14. The method according to claim 1, wherein said building panel is a NAF (no added formaldehyde) panel and a NAM (no added melamine) panel.

15. The method according to claim 1, wherein said building panel is configured to be a floor panel, a furniture component, a worktop, a wall panel or a ceiling panel.

16. A building panel, comprising:
a substrate, and
a front layer attached to a front surface of the substrate,
wherein the front layer comprises a thermosetting, no added formaldehyde (NAF) binder, wherein the substrate has an internal bond strength of 0.2-2.0 N/mm², and wherein internal bond strength is measured in accordance with EN319.

17. The building panel according to claim 16, wherein the front layer comprises at least 25 wt-% of said NAF binder.

18. The building panel according to claim 16, wherein the substrate is a wood-based board.

19. The building panel according to claim 16, wherein the substrate comprises at least 50 wt-% of recycled material.

20. The building panel according to claim 16, wherein the substrate comprises at least 30 wt-% of virgin, biobased material.

21. The building panel according to claim 16, wherein said building panel is a no added formaldehyde (NAF) panel and a no added melamine (NAM) panel.

22. The building panel according to claim 16, wherein said building panel is a floor panel, a furniture component, a worktop, a wall panel or a ceiling panel.
